(19) United States
(12) Patent Application Publication
(10) Pub. No.: US 2019/0097213 A1
(43) Pub. Date: Mar. 28, 2019

(54) PROCESSES AND COMPOSITIONS TO IMPROVE HIGH-TEMPERATURE PERFORMANCE OF NIMH BATTERIES

(71) Applicant: BASF CORPORATION, Florham Park, NJ (US)

(72) Inventor: Kwo Young, Troy, MI (US)

(21) Appl. No.: 15/718,136

(22) Filed: Sep. 28, 2017

(51) Int. Cl. H01M 4/36; H01M 10/30; H01M 10/26; H01M 4/32; H01M 4/38

(52) U.S. Cl. CPC H01M 4/366; H01M 10/30; H01M 2300/0014; H01M 4/32; H01M 4/381; H01M 10/26

(57) ABSTRACT

Provided are electrochemical cells and methods of their formation that include a negative electrode with a functional protective coating that protects against surface passivation by reducing growth of a passivating layer on the active material surface and that functions synergistically with a silicate containing alkaline electrolyte to reduce thickness of newly formed passivation layers that occur as a result of decrepitation during cycling. The cells and methods have particular advantages of improved cycle life at when exposed to high temperatures.

### FIELD

This disclosure relates to electrodes suitable for use in secondary batteries, and more particularly to the processes and electrodes that provide improved cycle stability at high-temperature.

### BACKGROUND

Nickel containing rechargeable alkaline cells are presently in wide use in battery systems including nickel metal hydride batteries and the like. In general, NiMH cells employ a negative electrode made of a hydrogen storage alloy that is capable of the reversible electrochemical storage of hydrogen. NiMH cells also typically employ a positive electrode made from a nickel hydroxide active material. The negative and positive electrodes are disposed in an alkaline electrolyte and separated by a body of spacer material so as to form an electrochemical cell. Upon the application of an electrical potential across the NiMH cell, water is dissociated into one hydroxyl ion and one hydrogen ion at the surface of the negative electrode. The hydrogen ion combines with one electron and diffuses into the bulk of the hydrogen storage alloy. This reaction is reversible. Upon discharge the stored hydrogen is released to form a water molecule and release an electron.

The development of commercially viable NiMH batteries began in the 1980s with the improvement of the negative electrode materials which resulted from making them “disordered” as taught by Ovshinsky et al. in U.S. Pat. No. 4,623,597. Such negative electrode materials represented a total departure from other teachings of that period which advocated the formation of homogeneous and single phase negative electrodes. (For a more detailed discussion see U.S. Pat. Nos. 5,096,667; 5,104,617; 5,238,756; 5,277,999; 5,407,761; and 5,536,591 and the discussion contained therein.) Use of such disordered negative electrode metal hydride materials significantly increases the reversible hydrogen storage characteristics required for efficient and economical battery applications and results in the commercial production of batteries having high density energy storage, efficient reversibility, high electrical efficiency, bulk hydrogen storage without structural change or poisoning, long cycle life, and deep discharge capability.

Further improvements in the performance of NiMH batteries resulted from improvements in the nickel hydroxide material incorporated into the positive electrodes of the batteries. In that regard, modifying and/or doping elements were added to the nickel hydroxide material so as to improve their structural and/or electronic properties. Some such compensating and/or doping materials include Co, Cd, Zn, Mg, and Ca among others. Such materials are disclosed in U.S. Pat. Nos. 6,228,535; Re. 34,752; 5,366,831; 5,451,475; 5,455,125; 5,466,543; 5,489,314; 5,506,070; and 5,571,636.

Charge capacity is a measure of how much electrical energy a battery is capable of storing and delivering. Consequently, charge capacity is a very important characteristic of any type of battery. Significant strides have been made toward improving the charge capacity of rechargeable battery systems. However, performance characteristics of rechargeable batteries, including charge capacity, are adversely impacted when the battery systems are run under elevated temperature conditions. For example, in conventional NiMH batteries it has been found that operation under even modestly elevated temperatures such as 55° C. can reduce the run time of a battery by 35 to 55 percent compared to room temperature operation of the same battery.

There are two general issues that lead to reduced charge efficiency of a battery in the context of high-temperature performance. The first is charge acceptance at elevated temperature that is affected by decreasing oxygen evolution potential of the electrode active material. Prior methods to address this are the formation of new positive electrode chemistries or the doping of an additive into the electrolyte, such as Na₂WO₄, either of which can be used to raise the oxygen evolution potential of the cathode material.

The second issue leading to reduced charge efficiency is the oxidation of the MH alloy at higher temperature and/or due to the strongly oxidizing electrolyte used in these cells. Oxidation leads to either corrosion to form soluble complex ions or passivation to form thick surface oxides that prevent the necessary electrochemical reactions for cell function. Particularly, for a negative electrode, the surface must be kept fresh without sacrificing too much active material in the process. To assist in this, prior materials have used high percentages of Ni and Cr to protect AB₂ alloys, for example, from corrosion at high temperature. For La containing negative electrode materials, the addition of other rare earth elements such as Y, Er, or Yb may retard the La₂O₃ formation on the AB₅ surface. Finally, the addition of B2 secondary phase with higher solubility in the electrolyte may also be beneficial to keep the surface active during high temperature charge.

Given the fact that rechargeable batteries often must operate under elevated temperature conditions, any improvements in their high temperature charge efficiency will be of great commercial significance. As will be explained hereinbelow, the present disclosure is based upon the finding that the high-temperature performance of rechargeable alkaline batteries that contain negative electrode active materials including a rare earth can be significantly improved by including both a silicate additive in the electrolyte and placing a thin protective coating layer on the surface of the negative electrode material where the coating is a surface metal oxide and/or hydroxide. These and other advantages of the disclosure will be apparent from the drawings, discussion, and description which follow.

### SUMMARY

The following summary is provided to facilitate an understanding of some of the innovative features unique to the present disclosure and is not intended to be a full description. A full appreciation of the various aspects of the disclosure can be gained by taking the entire specification, claims, drawings, and abstract as a whole.

Provided are electrochemical cells with electrode structure and electrolyte that work in concert to improve high-temperature cycle stability of the cell by stabilizing the electrode active material during cycling. Such is achieved by an electrochemical cell that includes a positive electrode, a negative electrode, a separator between an active surface of the positive electrode and the negative electrode, and an alkaline electrolyte including a silicate. The negative electrode includes a conductive substrate, an electrochemically active material layer coated onto the substrate, and a metal oxide/hydroxide coating layer, the coating layer directly on the active material layer opposite the substrate, the coating layer comprising a rare earth element. The rare earth containing coating layer prevents substantial passivation of the electrode surface due to oxidation of the electrode active material and the silicate in the electrolyte reduces the thickness of passivation layers occurring during cycling as a result of decrepitation of the active material.

The coating layer is optionally compositionally different than the electrochemically active material and is optionally unable to participate in an electrochemical reaction. Optionally, the rare earth is yttrium. A coating layer has a thickness that may be 0.01 to 10 micrometers. The active material is optionally any suitable electrochemically active material for use with an alkaline electrolyte, but optionally has a main phase structure selected from the group consisting of BCC solid solution, AB₂, AB₅, and A₂B₇. In some aspects, the electrochemically active material includes one or more rare earth elements, optionally Y, La, Ce, Pr, Nd, or combinations thereof. Optionally, the rare earth element in the electrochemically active material is different than the rare earth in the coating layer. Optionally, the rare earth in the coating layer is Y, and the rare earth in the electrochemically active material is La, Ce, Pr, Nd, or combinations thereof. In some aspects, an electrochemically active material includes Ni, optionally Ni and one or more rare earth elements, optionally combined with a coating layer that includes Y. The alkaline electrolyte includes one or more silicates as an additive where the alkaline metal to Si atomic ratio is less than 2, optionally at or less than 1.9. In particular exemplary aspects, an electrochemically active material includes Ni and one or more rare earth elements selected from the group consisting of Y, La, Ce, Pr, Nd, other rare earth elements, or combinations thereof, and the alkaline electrolyte includes a Na or K silicate. Optionally, a coating layer includes a yttrium oxide/hydroxide and an electrochemically active material includes La, Ce, Pr, Nd or combinations thereof. In any of the forgoing aspects, the resulting electrochemical cell optionally has a residual capacity of 80% or greater at cycle 100, optionally at cycle 400, optionally at cycle 500.

Also provided are processes of forming an electrochemical cell that include forming a negative electrode by layering a coating of rare earth oxide, optionally yttrium oxide, onto an electrochemically active material suitable for use with an alkaline electrolyte, and contacting the negative electrode with an alkaline electrolyte comprising a silicate. Optionally, the process produces any of the electrochemical cells as provided above or otherwise herein. The electrochemically active material optionally has a main phase structure selected from the group consisting of BCC solid solution, AB₂, AB₅, and A₂B₇. Optionally, the electrochemically active material includes one or more rare earth elements, optionally Y, La, Ce, Pr, Nd, or combinations thereof. Optionally, the step of layering is by a sol-gel method, a dip coating method, or combinations thereof.

Also provided are processes of improving the high-temperature performance of an electrochemical cell including forming a negative electrode by layering an electrochemically active material on a conductive substrate and coating the electrochemically active material with a layer of rare earth oxide, contacting the negative electrode with an alkaline electrolyte comprising a silicate, and forming a silicate film on a surface of the electrochemically active material. The step of forming the silicate film optionally includes cycling the electrochemical cell in the presence of a silicate in the electrolyte and an active material within the negative electrode. In some aspects, the atomic ratio of alkali metal to Si is less than 2, optionally at or less than 1.9. Optionally, the silicate film includes one or more rare earth elements and Si. Optionally, the silicate film includes La₂(SiO₃)₃, Ce₂(SiO₃)₃, Pr₂(SiO₃)₃, Nd₂(SiO₃)₃ or combinations thereof. Optionally, the rare earth in the silicate film is obtained from the electrochemically active material, and optionally is different than the rare earth element in the coating layer. Optionally, the rare earth in the rare earth oxide is yttrium. A rare earth oxide layer has a thickness that may be 0.01 to 10 micrometers. The active material is optionally any suitable electrochemically active material for use with an alkaline electrolyte, but optionally has a main phase structure selected from the group consisting of BCC solid solution, AB₂, AB₅, and A₂B₇. In some aspects, the electrochemically active material includes one or more rare earth elements, optionally Y, La, Ce, Pr, Nd, or combinations thereof. In some aspects, an electrochemically active material include Ni, optionally Ni and one or more rare earth elements. In particular exemplary aspects, an electrochemically active material includes Ni and one or more rare earth elements selected from the group consisting of Y, La, Ce, Pr, Nd, other rare earth elements, or combinations thereof, and the alkaline electrolyte includes a Na or K silicate.

### BRIEF DESCRIPTION OF THE DRAWINGS

The aspects set forth in the drawings are illustrative and exemplary in nature and not intended to limit the subject matter defined by the claims. The following detailed description of the illustrative aspects can be understood when read in conjunction with the following drawings in which:

FIG. 1 illustrates the electrochemical performance of exemplary cells including an AB₅ type negative electrode active material coated with Y₂O₃ and tested in a silicate containing KOH electrolyte relative to control cells illustrating excellent cycle life;

FIG. 2 illustrates the electrochemical performance of exemplary cells including an AB₂ type negative electrode active material coated with Y₂O₃ and tested in a silicate containing KOH electrolyte relative to control cells illustrating small improvements in cycle life, particularly at large cycle numbers;

FIG. 3 illustrates the electrochemical performance of exemplary cells including an A₂B₇ type negative electrode active material coated with Y₂O₃ and tested in a silicate containing KOH electrolyte relative to control cells illustrating excellent cycle life; and

FIG. 4 illustrates the electrochemical performance of exemplary cells including an BCC type negative electrode active material coated with Y₂O₃ and tested in a silicate containing KOH electrolyte relative to control cells illustrating small improvements in cycle life, particularly at large cycle numbers.

### DETAILED DESCRIPTION

The following description of particular aspect(s) is merely exemplary in nature and is in no way intended to limit the scope of the invention, its application, or uses, which may, of course, vary. The disclosure is provided with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials may be interchangeable such that the description of the invention may include multiple parts or steps arranged in many ways as is readily appreciated by one of skill in the art.

It will be understood that, although the terms “first,” “second,” “third” etc. may be used herein to describe various elements, components, regions, layers, and/or sections, these elements, components, regions, layers, and/or sections should not be limited by these terms.

These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

For purposes of this disclosure, the terms “batteries” and “cells” will be used interchangeably when referring to one electrochemical cell, although the term “battery” can also refer to a plurality of electrically interconnected cells.

As used herein, the term “electrochemically active” is intended to mean that the material functions in the absorption or desorption of proton accompanied by the electron in and out from the outside circuitry during electrochemical cycling.

As defined herein, an “anode” or “negative electrode” includes a material that acts as an electron acceptor during charge.

As defined herein, a “cathode” or “positive electrode” includes a material that acts as an electron donor during charge.

As used herein the term “high temperature” is understood to mean temperatures at or above 40° C., and more typically at or above 50° C.

While the present discussion focuses primarily on nickel metal hydride (NiMH) batteries, it should be understood that the electrode structures of the present invention can be used in other types of batteries which include metal hydroxide based negative electrode materials.

Provided are electrochemical cells that include a negative electrode based on a metal hydride containing electrochemically active material. Such materials are understood to suffer from reduced performance at high temperature. Much of this reduced performance is due to decrepitation of the active material that creates large newly exposed surfaces during cycling. It was found that forming a renewable coating on the surface of a negative electrode active material in contact with an electrolyte where the coating includes a material capable of providing ions that may from an oxide on the surface combined with use of an electrolyte that includes a silicate in contact with the surface coating allows for the renewable formation of high density thin film layers with the coating layer material. This dramatically reduces unwanted surface passivation and extends cell performance in high-temperature situations.

As such, provided are electrochemical cells that include a positive electrode, a negative electrode, a separator, and alkaline electrolyte including a silicate, where the negative electrode includes a conductive substrate, an electrochemically active material layer coated onto the substrate, and a coating layer including one or more metal oxides/hydroxides the coating layer directly on the active material layer opposite the substrate, the coating layer comprising a rare earth element.

An electrochemical cell optionally includes a positive electrode with a cathode active material suitable for use in a primary battery or a secondary battery. In some aspects, a cathode active material includes or is a hydroxide. Illustratively, a metal hydroxide such as nickel hydroxide is used or included in a cathode active material. A metal hydroxide is optionally an alloy of 1 to 5 transition metal elements. A cathode active material is optionally nickel hydroxide based. The term “nickel hydroxide based” is defined herein as including a nickel hydroxide as the predominant cathode electrochemically active material. In some aspects, a nickel hydroxide based material used in a cathode is solely Ni(OH)₂ as the active material. Such cathode active materials are commercially available as recognized in the art. Illustrative examples of cathode active materials can be found in U.S. Pat. No. 5,344,728 and 5,348,822 (which describe stabilized disordered positive electrode materials) and U.S. Pat. Nos. 5,569,563, 5,567,549, 6,027,834, 6,338,917, 7,147,676, 9,406,934, and 9,425,456.

A cathode active material optionally includes one or more transition metal elements. Illustrative examples of a transition metal element included in a cathode active material include Ni, Co, Mn, Zn, Al, among others. Optionally, one or more additives are provided. An additive used in a Ni-based cathode active material is optionally Ca, Mg, Y, Al, Ba, Co, Cr, Cu, F, Fe, K, Li, Mn, Na, Sr, Zn, one or more lanthanides, among others. In some aspects, a cathode active material is a hydroxide of Ni, Co, and Zn alone or along with additives, optionally Ca or Mg. Optionally, a cathode active material is Ni₉₁Co₇Zn_{0.5}Ca₁Mg_{0.5}. Illustrative examples of cathode active materials and their methods of manufacture can be found in Fierro et al, Journal of The Electrochemical Society, 153(3), A492-A496 (2006).

An electrochemical cell includes a negative electrode with an anode active material. An anode active material is suitable for use in an alkaline or non-aqueous proton-conducting battery. In some aspects, an anode active material is capable of storing hydrogen electrochemically. Storing hydrogen electrochemically is understood as being capable of reversibly absorbing and desorbing hydrogen. One particular group of MH materials having utility in an electrochemical cell as provided herein is known as the ABₓ class of materials where x is typically between 0.5 and 5.4, X is optionally 2, 3.5, or 5. Illustrative examples of ABₓ type materials are disclosed, for example, in U.S. Pat. Nos. 5,536,591, 6,210,498, 7,211,541, 7,344,676, 7,393,500, 8,877,378, 9,324,470, and U.S. Patent Application Publication No: 2016/0028083. Optionally, an anode active material has a chemical structure of AB₂, A₂B₇, or AB₅, among others. Such materials may include, but are not limited to, modified LaNi₅ type (AB₅) as well as the Laves-phase based active materials (AB₂). Illustrative examples of AB₂ materials optionally have a generic Ti—Zr—Ni composition, where at least Ti, Zr, and Ni are present with at least one or more modifiers from the group of Cr, Mn, Co, Sn, Co, V, and Al. The materials are multiphase materials, which may contain, but are not limited to, one or more Laves phase crystal structures and other non-Laves secondary phase.

Rare earth (RE) magnesium-based AB₃— or superlattice-based (optionally A₂B₇) MH alloys may also be used as MH alloys in negative electrodes. While most of the RE-Mg-Ni MH alloys were based on La-only as the rare earth metal, Nd-only A₂B₇ (or AB₃) alloys may also be used. Illustrative examples of superlattice-based metal hydride alloys that may be used are described in Young, et al., J. Power Sources, 2015; 277:426-432.

Other ABₓ materials include the Laves phase-related body centered cubic (BCC) materials that are a family of MH alloys with a two-phase microstructure including a BCC phase and a Laves phase historically present as C14 as an example. Illustrative examples of such BCC materials may be found in Young et al., Batteries, 2015; 1:34-53.

An anode active material as used in an electrochemical cell according to some aspects optionally includes a hydride forming metal component (A). A hydride forming metal component is optionally lanthanum, cerium, praseodymium, neodymium, promethium, samarium, yttrium, or combinations thereof or other metal(s) such as a mischmetal. In some aspects, a hydride forming metal component includes neodymium. A B component optionally includes a metal selected from the group of aluminum, nickel, cobalt, copper, and manganese, or combinations thereof. In some aspects, a B component includes nickel. The A component, the B component, or both may be partially substituted by one or more elements that may be titanium, zirconium, vanadium, chromium, cobalt, aluminum, or combinations thereof optionally together with modifier elements which may include silicon, tin, molybdenum, yttrium, antimony, or combinations thereof. In particular aspects, an A component includes a rare earth and a B component includes nickel. Illustrative examples of such materials may be found in U.S. Patent Application Publication No: 2016/023346.

In some aspects, an anode active material includes three or more transition metals that are optionally disordered within the structure of the alloy material. Illustrative examples of a transition metal that may be included in an anode active material are Ti, V, Cr, Mn, Fe, Co, Ni, Cu, Zn, Ag, Au, Cd, or combinations thereof. In some aspects, a transition metal includes Cd, Ni, Co, Fe, Zn, Mn, or combinations thereof. Optionally, a single transition metal is present as a predominant. Optionally, an anode active material optionally includes a first transition metal as a predominant and a second transition metal at an atomic percentage of 5% or greater. A second transition metal is optionally present at an atomic percentage of at or greater than 5%, 6%, 7%, 8%, 9%, 10%, 11%, 12%, 13%, 14%, 15%, or greater. In some aspects, an anode active material optionally includes a nickel hydroxide based disordered material where nickel hydroxide based means predominantly nickel hydroxide.

An anode active material optionally is formed of more than one phase. Optionally, an anode active material includes a primary phase (or main phase) and one or more secondary phases. A primary phase is a material phase that is present as a predominant in the overall alloy, optionally at a phase abundance of 30 weight percent or greater, optionally 50 weight percent or greater. In some aspects, a primary phase is represented by an A₂B₇ phase or an AB₅ phase. One or more secondary phases are optionally also present in an anode active material. Optionally, the number of secondary phases is 1, 2, 3, 4, 5, 6, 7, or more. A secondary phase is optionally present at a phase abundance of 2% to 8% in the material, or any value or range therebetween.

Optionally, a secondary phase is present at a level of 2% to 6%. Optionally, a secondary phase is present at a phase abundance percent level of 2, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, or 6.

An anode active material or a cathode active material may be formed by a mechanical alloying processes such as ball milling, impact milling, attritor milling, and the like, which may be utilized to at least partially alloy the particles mechanically. In some aspects, an active material is formed into an ingot by induction melting and subjecting the ingot to annealing in an inert gas such as argon, or by a melt-spin process such as that described by Srivastava and Srivastava, Journal of Alloys and Compounds, 1998; 267:240-245. An anode or cathode active material is optionally formed by a co-precipitation process such as that described in U.S. Patent Application Publication No: 2012/0009476.

In examples of annealing, an ingot is prepared by methods well recognized in the art such as by the combination of raw materials that are melted by high-frequency induction. Optionally, an ingot of a hydride forming metal as an A component, a B component, and optionally one or more additives or modifier elements, are annealed at an annealing temperature of, for example, 825° C. or greater for an annealing time to produce the resulting anode active material or portion thereof. An annealing temperature used in a process is 825° C. or greater, optionally 900° C. or greater. Optionally, an annealing temperature is from 925° C. to 950° C. Optionally, an annealing temp is 825, 850, 875, 900, 925, 930, 935, 940, 945, or 950° C., or any value or range at or between 825° C. and 950° C. An annealing temperature is applied to an ingot for an annealing time. At an annealing temperature of 925° C. to 950° C., an annealing time is optionally from 3 hours to 15 hours, or any value or range therebetween. Optionally, an annealing time is from 4 hours to 10 hours. Optionally, an annealing time is from 4 hours to 6 hours. Optionally, an annealing time is 3, 4, 5, 6, 7, 8, 9, 10, 11, 12, 13, 14, or 15 hours.

An anode or cathode active material is optionally formed by a melt-spin process. An exemplary melt-spin process is achieved by mixing and pelletizing a combination of raw materials in stoichiometric ratio, and then melting the mixture in a radio frequency induction furnace in an argon atmosphere. Ingots are then subjected to rapid solidification by pouring alloy material on a copper wheel rotating at a speed of approximately 5000 rpm, leading to cooling rates of 10² to 10³ K⁻¹ S⁻¹.

An anode or a cathode may be formed by intermixing a desired amount of an active powder material and an optional binder material such as a synthetic resin powder or the like (optionally at 1-10% by weight of solvent) in a solvent to prepare a slurry and applying the resulting slurry to a substrate followed by drying and optionally pressing. Exemplary binders include, but are not limited to, polyvinyl alcohol, carboxymethyl cellulose, hydroxypropyl cellulose, diacetyl cellulose, polyvinyl chloride, carboxylated polyvinyl chloride, polyvinyl fluoride, and a polymer having ethylene oxide, polyvinylpyrrolidone, polyurethane, polytetrafluoroethylene, polyvinylidene fluoride, polyethylene, polypropylene, styrene-butadiene rubber (SBR), acrylated SBR, epoxy resin, and nylon. Examples of solvent include carbonate-based, ester-based, ether-based, ketone-based, alcohol-based, or aprotic solvents. Illustrative solvents include SMEO, N-methylpyrrolidone (NMP), ethylene glycol and water.

The mixture can also include a thickener, such as an aqueous solution of carboxymethylcellulose (CMC) or the like, to form a paste. In some aspects, a conduction promoter is included in an electrode active material, optionally copper.

A paste of active material may be layered or pressed upon an electrochemically conductive substrate optionally in the form of a plate or sheet, optionally porous, and optionally made of nickel or nickel-plated steel, copper, aluminum, or combinations thereof. The substrate can be a punched or perforated sheet, an expanded plate, screen, or the like. After the active material is contacted to the substrate, the resulting anode or cathode may be sintered. The form of a porous metal substrate optionally includes, but is not limited to, mesh, grid, matte, foil, foam, plate, and expanded metal. Optionally, the porous metal substrate is foam. In some aspects, a porous metal substrate is formed from copper, copper-plated nickel, or a copper-nickel alloy. To protect the porous metal substrate of the from the harsh battery environment, the porous metal substrate may be plated with a material which is electrically conductive yet resistant to corrosion in the battery environment. In some aspects, the porous metal substrate may be plated with nickel.

The conductivity of the electrode can also be increased by copper plating after the active material has been compressed (and possibly sintered) onto the substrate. The copper plating may be patterned or unpatterned. As well as increasing electrode conductivity, the copper plating provides an additional means of ensuring that the active material remains adhered to the substrate.

As noted above, a negative electrode further includes a coating where the coating includes a metal oxide and/or metal hydroxide (referred to herein as metal oxide/hydroxide). In some aspects, a coating includes a metal oxide, optionally excluding a metal hydroxide. A coating functions in the negative electrode as a layer that reduces the growth of a passivation layer on the active material surface. The metal in the metal oxide is partially soluble in the electrolyte near the surface. During cycling, particularly at high temperature, oxidation of the underlying active material causes some of the rare earth (or other metal) in the electrochemically active material to leech into the coating layer. The mixed active/coating metal material is then precipitated on the electrode surface in the form of a mixed oxide/hydroxide. This mixed material grows more slowly than pure active material metal (e.g., rare earth) oxide/hydroxide thereby reducing the rate at which a thick passivating layer is created and extending cycle life.

A coating on a negative electrode includes one or more materials that provide ions capable of participating in the formation of an oxide, hydroxide, or both. Illustrative examples of materials that may be included in a coating include or are exclusively one or more metal oxides. Illustrative examples of a metal oxide coating layers include but are not limited to Y₂O₃, Yb₂O₃, Sm₂O₃, Eu₂O₄, Gd₂O₃, or combinations thereof, optionally also including hydroxides of these metals. In some examples a coating includes Y, optionally Y as the exclusive metal in the metal oxide coating layer.

A coating layer has a thickness. A thickness of a coating layer is optionally 0.01 to 10 micrometers, or any value or range therebetween. Optionally, a coating is 0.01 to 1 micrometers, optionally 0.01 to 5 micrometers, optionally 0.05 to 5 micrometers, optionally 0.05 to 1 micrometers, optionally 0.1 to 5 micrometers, optionally 0.1 to 1 micrometer.

A coating may be applied to a negative electrode material by any suitable method. Illustrative examples of coating methods include formation of a sol-gel film, dip coating or spray coating. A coating is optionally applied by a sol-gel method. In one example, a metal is Y and is used to grow a coating directly on the surface of the active material layer of the electrode. A precursor of yttrium alkoxide (e.g., as Y(O—C₂H₅)₃ or [Y(OC₂H₄OCH₃)₃]₁₀). The precursor dissolves in an alcohol which is then contacted to the surface of the electrode. The yttrium alkoxide reacts with water in the air to undergo hydrolysis and polycondensation resulting in a yttrium oxide coating layer on the surface. The coated electrode may then be dried in air for several hours and then calcined at a desired temperature and time, optionally 300° C. for 2 hours.

In other aspects a coating is applied by a dip coating method. A conductive substrate optionally coated with active material on both sides is dipped into an alcohol solution of yttrium alkoxide which then coats the surface. The resulting condensation reaction occurs in air containing water leading to the resulting oxide coating on both surfaces of the electrode. The dip coating method has advantages in being easier to use to form mixed metal oxides on the surface with varying ratios of elements, as well as improved homogeneity and stability to the environment. The coated electrode may be dried in air for several hours and then calcined at a desired temperature and time, optionally 300° C. for 2 hours.

Alternatively, a coating may be layered upon an anode active material by spray coating. In this process a metal alkoxide such as yttrium alkoxide is dissolved in ethanol and sprayed onto the surface from nozzles designed to spray a fog of fine droplets onto the surface. The plate may be dried in air for several hours and then calcined at a desired temperature and time, optionally 300° C. for 2 hours.

An electrochemical cell includes an electrolyte suitable for use in a metal hydride electrochemical cell. An electrolyte is optionally an electrolyte capable of and/or used for conducting protons or hydroxyl ions. An electrolyte is optionally an alkaline electrolyte. An electrolyte is optionally a liquid electrolyte or a solid electrolyte. In some aspects, an electrolyte is a gel or solid electrolyte. An electrolyte may be a non-aqueous electrolyte meaning that the electrolyte does not contain a significant amount of water where “significant amount” is recognized in the art. An electrolyte is optionally a solid electrolyte such as in the form of a polymer or gel. In this context, the polymer electrolyte may be either a true polymer, or the polymer may be plasticized or gelled with the addition of at least one low molecular weight organic liquid.

An electrolyte is optionally a liquid electrolyte, optionally an alkaline electrolyte. Illustrative examples of electrolytes are KOH, NaOH, LiOH, Ca(OH)₂, among others, in any suitable concentration, optionally 20 to 45 weight percent in water.

An electrolyte is optionally a solid polymer electrolyte that is either aqueous or non-aqueous. An illustrative example of such a polymer electrolyte is formed from poly(ethylene oxide), potassium hydroxide, and water. Other polymeric materials useful for the formation of alkaline electrolytes include poly(ethylene oxide), poly(vinyl alcohol), poly(acrylic acid), or a copolymer of epichlorohydrin and ethylene oxide each with KOH or NaOH.

Other examples of electrolytes include organic solutions (e.g. propylene carbonate (PC), ethylene carbonate (EC), dimethylformamide (DMF), dimethyl sulfoxide (DMSO), or Polyvinyl alcohol (PVA)) with added acid, protic ionic liquids (e.g. diethylmethylammonium trifluoromethanesulfonate (DEMA TfO), triethylamine: methylsulfonic acid ([Et3N][MsOH]), 2-methylpyridine:trifluromethanesulfonic acid (1:2), or 1-ethyl-3-methylimmidazolium dicyanamide (EMI-DCA)), aprotic ionic liquids with acid added, among others known in the art.

An electrolyte is optionally a protic ionic liquid. A protic ionic liquid electrolyte is formed from proton transfer from a Bronsted acid to a Bronsted base. Illustrative examples of such electrolyte materials include those found in international patent application publication WO 2014153642. In the case of DEMA-TfO pair, DEMA is an acid with a detachable proton.

An electrolyte includes one or more additives that may react with a coating layer on a negative electrode so as to form new protective layers on newly formed anode active material during cycling. An additive is optionally in the form of a liquid prior to combination with an electrolyte. An additive is illustratively a silicate additive. Illustrative examples of a silicate additive include silicate salts of Na, K, or others, optionally including but are not limited to Na₂SiO₃, K₂SiO₃, K₄Si₃O₈, K₄SiO₄, K₆SiO₆, or combinations thereof. Other alkali metal salt silicates may also be used. During cycling, the decrepitation of the anode active material continuously exposes fresh material to the environment. In the absence of an additive the rare earth in the exposed surface forms a thick passivating layer that reduces performance. The additive in the electrolyte reacts with the rare earth exposed during cycling in the anode active material to form a thin layer that allows continued penetration of ions during cycling and thereby extending cycle life. As an example, in the presence of silicon oxide, the presence of the silicon converts La(OH)₃ converts into La₂(SiO₃)₃ which is thinner and much more conductive of ions than the impassive La(OH)₃.

The relative amount of alkaline to silicate salt in an additive containing electrolyte is optionally at an atomic ratio of less than 2. In illustrative aspects the atomic ratio of alkaline to silicate is at or less than 1.9, 1.8, 1.7, 1.6, 1.5, 1.4, 1.3, 1.2, 1.1, 1.0, 0.9, 0.8, 0.7, 0.6, or 0.5. The atomic ratio of alkaline to silicate is optionally from 0.5 to less than 2.0, optionally 0.5 to 1.5, optionally 0.6 to 1.

The resulting combination of a metal oxide coating layer and a suitable additive in the electrolyte functions synergistically to dramatically improve cycle life of an electrochemical cell employing these materials. As a result, cycle life is optionally at or greater than 80% residual capacity or greater at cycle 100, optionally at cycle 110, optionally at cycle 120, optionally at cycle 130, optionally at cycle 140, optionally at cycle 150, optionally at cycle 160, optionally at cycle 170, optionally at cycle 180, optionally at cycle 190, optionally at cycle 200 optionally at cycle 250, optionally at cycle 300, optionally at cycle 350, optionally at cycle 400, optionally at cycle 450, optionally at cycle 500.

Relative to an electrochemical cell with identical electrodes but absent a coating on the negative electrode and absent an additive in the electrolyte as described herein, the improvement in cycle life is optionally a relative residual capacity at cycle 100 of 10% or greater, optionally 12% or greater, optionally 15% or greater. Optionally the cells as provided herein relative to an electrochemical cell with identical electrodes but absent a coating on the negative electrode and absent an additive in the electrolyte as described herein is optionally a relative residual capacity of 30% or greater, 35% or greater, 40% or greater, 45% or greater, or 50% or greater at cycle 200. The improved cycle life is measured as the improved capacity of the electrochemical cells as provided herein over the control.

Various aspects of the present invention are illustrated by the following non-limiting examples. The examples are for illustrative purposes and are not a limitation on any practice of the present invention. It will be understood that variations and modifications can be made without departing from the spirit and scope of the invention.

### Experimental

A set of exemplary alkaline half cells were constructed using a positive electrode formed of 80% Ni(OH)₂ and 20% graphite-PTFE mixture formed as a dry mixture and layered onto a nickel screen an electrode substrate. Four separate types of negative electrodes were prepared using electrode active materials as illustrated in Table 1.

TABLE 1
Negative electrode active materials

| | Composition | Production method |
|---|---|---|
| AB₅ | La_{10.5}Ce_{4.3}Pr_{0.5}Nd_{1.4}Ni_{60.0}Co_{12.7}Mn_{5.9}Al_{4.7} | Induction melting |
| AB₂ | Ti₁₂Zr_{21.5}Ni_{36.2}V_{9.5}Cr_{4.5}Mn_{13.6}Sn_{0.3}Co₂Al_{0.4} | Induction melting |
| A₂B₇ | La_{3.9}Pr_{7.6}Nd_{7.6}Mg_{3.9}Ni_{73.0}Al_{4.0} | Induction melting |
| BCC | Ti_{14.5}Zr_{1.7}V_{46.6}Cr_{11.9}Mn_{6.5}Co_{1.5}Ni_{16.9}Al_{0.4} | Arc melting |

Methods of formation and testing of the negative electrode material is described in Young, et al., J. Alloys Cpds, 2014; 585:760-770. The negative electrode active material is formed by combining the raw materials and subjecting the raw ingots to induction melting in an argon atmosphere in a MgO crucible or to arc melting at a temperature above the melting point of the constituent elements. The ingots were annealed at in vacuum (1×10⁻⁸ torr) at 960° C. for 10 h.

The obtained ingots were powdered and put through a sieve of below 75 μm size. A material mixture paste was made up from 100 parts by weight of each negative electrode active material, 0.125 part by weight of carboxymethylcellulose (CMC), 0.5 part by weight of sodium polyacrylate (PAS) having the function of a thickener a bonding agent, 0.5 part by weight of acetylene black (AB) as a conductance assistant, and 30-50 part by weight of water, as well as 2.5 part by weight of a polytetrafluoroethylene (PTFE) dispersion. The resultant material mixture paste was coated both surfaces of nickel-plated punched metal. The material mixture paste was dried and pressed together with the core material between rollers. The electrode plate thus obtained was cut, whereby a negative electrode of 0.4 mm in thickness and 15×15 mm square having about 0.5 gram active material was obtained.

For control electrodes, the resulting materials as above were used. For test electrodes, Y₂O₃ sol-gel thin films were grown directly on the metal hydride negative electrodes. The precursors utilized were yttrium alkoxide (such as Y(O—C₂H₅)₃ or [Y(OC₂H₄OCH₃)₃]₁₀ and H₂O. Yttrium alkoxide dissolved in ethanol is coated in the surface of negative electrodes. The electrodes are then heated to 300° C. for 2 hours. The yttrium alkoxide reacts with water in air and undergoes hydrolysis and polycondensation reactions, leading to the formation of yttrium oxide coating on the surface of the negative electrode.

Each metal hydride negative electrode was put into a separator bag made from nonwoven fabric made of a core/shell configuration fiber, in which a core of a polypropylene fiber was covered with an ethylene vinyl alcohol copolymer. The negative electrode was sandwiched with two positive electrodes. A half-cell is held by the sample holder, and immersed in a KOH electrolyte solution that included 30 wt % KOH aqueous solution for control cells or 30 wt % KOH aqueous solution plus a sodium silicate solution (Na₂O: 9 wt %, SiO₂:28 wt %, H₂O:63 wt %) for test cells. The sodium silicate is 2.5 wt % of total electrolyte weight and the atomic ratio of Na to Si is 0.7837. The standard electrolyte is used in control cells while the sodium silicate containing electrolyte solution is used with the coated negative electrode containing cells. Each entire half-cell system was sealed with Parafilm.

Half-cells were put into an environment controlled chamber, and were tested using an Arbin instrument. The nickel-metal hydride cells of the examples with silicate electrolyte and coated negative electrodes as well as control cells were charged at a current corresponding to 10 hours rate (30 mA/g) in an environment of 50° C. Thereafter, the charged cells were discharged at a current corresponding to 5 hours rate (60 mA/g) until the cell voltage reached 1.0 V at 50° C. This charge-discharge cycle was repeated 10 times. The cells were then charged at a current rate of 100 mA/g for 3 hours for AB₂, A₂B₇ and BCC cells and 2 hours and 50 minutes for AB₅ cells, then discharged at a current rate of 200 mA/g until the cell voltage reached 1.0 V at 50° C. for a total of 200 test cycles.

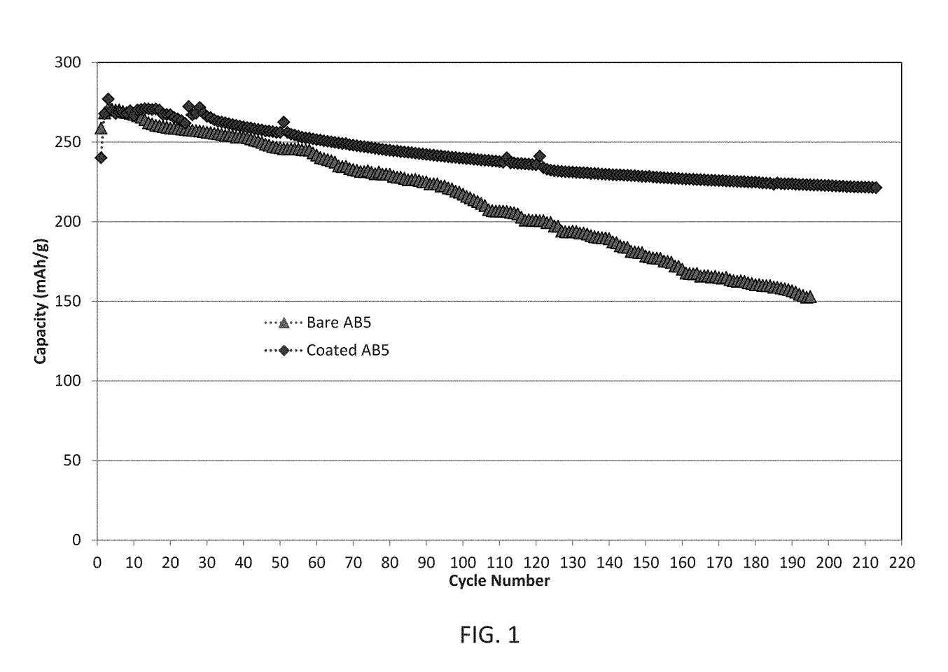

The results of for the exemplary AB₅ alloy are illustrated in FIG. 1. The test cells show greatly improved cycle life relative to control. Both are able to cycle out to 200 cycles, but the test cells show greatly improved residual capacity continuously throughout the testing. These results indicate that the coating on the negative electrode provides and interface with the electrolyte that is chemically stable so as to prevent cations in the alloys from dissolving in electrolyte. The coating does not reduce storage capacity of electrodes, but significantly improves the cycle stability. Overall, for an AB₅ alloy the Y₂O₃ coating and silicate added to the electrolyte are effective to improve cycle life performance at high temperatures.

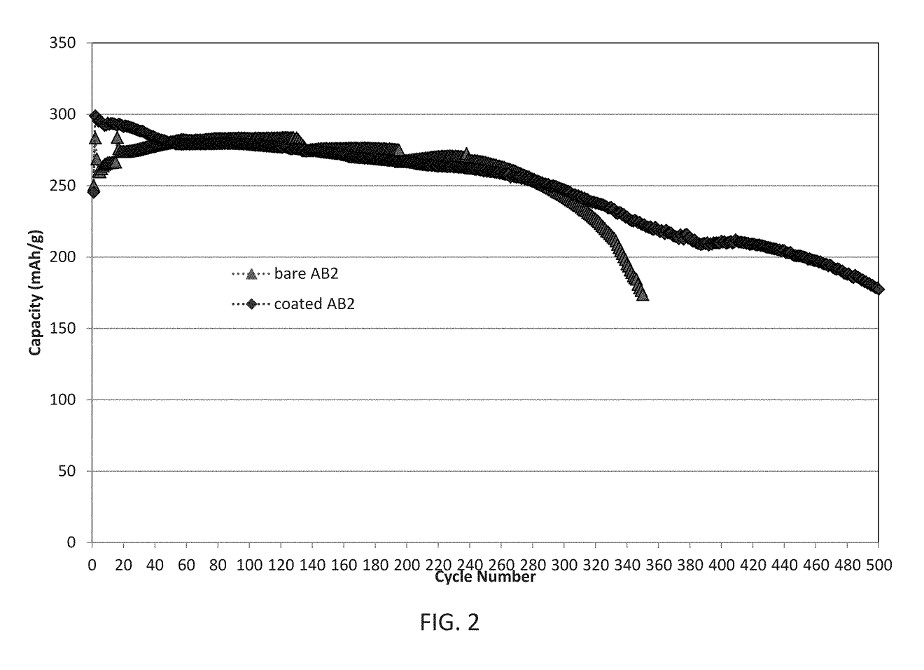

The exemplary cells including an AB₂ alloy in the negative electrode are compared as illustrated in FIG. 2. The Y₂O₃ coating on AB₂ electrode is less effect than on AB₅ due to a high density layer of zirconium oxide from the Zr contained in the active. It is this oxide layer that causes poor kinetics performance of AB₂ electrode at room temperatures. Alloy decrepitation is the main factor that leads to cycle life performance. At high temperatures, the alloy performance is improved as AB2 alloys show better kinetics at high temperatures. While there is little difference observed out to cycle 250, beyond that the control cell drops residual capacity precipitously while the coated negative electrode containing cell is able to continue performance out to 500 cycles as tested.

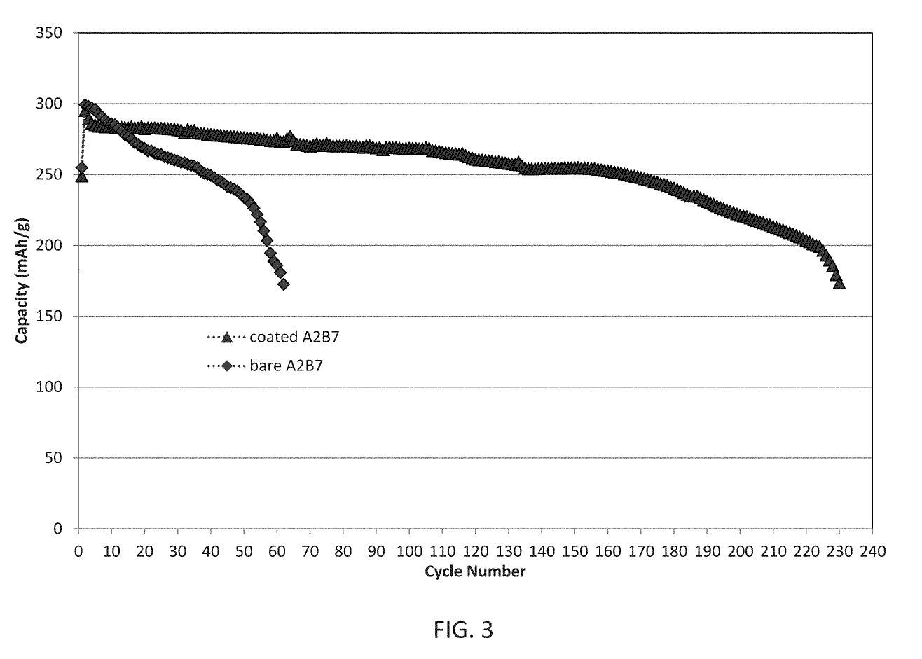

Significant improvements in cycle life are observed for the rare earth containing A₂B₇ materials in cells with a coated negative electrode and a silicate containing electrolyte. Formation of A₂B₇ phases requires additional magnesium because the small size of the magnesium atom prefers to stay in an AB₂ layer which promotes formation of alternative AB₂ and AB₅ layers. However, interactions between magnesium and nickel atoms are weaker than those between rare earths and nickel since rare earths have the intrinsic f orbits. In addition, A₂B₇ hydride tends to decompose because of its A/B ratio higher than that in AB₅. Therefore, cycle life performance of A₂B₇ electrodes is generally worse than that of AB₅, in particularly at high temperatures. Such poor performance is observed in the control cells of FIG. 3 that make clear that control A₂B₇ material is certainly not suitable for high-temperature applications. However, as illustrated in the test cells of FIG. 3, the Y₂O₃ coating provides a chemically stable interface that is also highly H+ ion conducting and that effectively reduces the chemical reaction between the electrode and the electrolyte. The coating can, therefore, allow the negative electrode to endure a larger variation of lattice parameters to reduce the decrepitation of the active electrode materials.

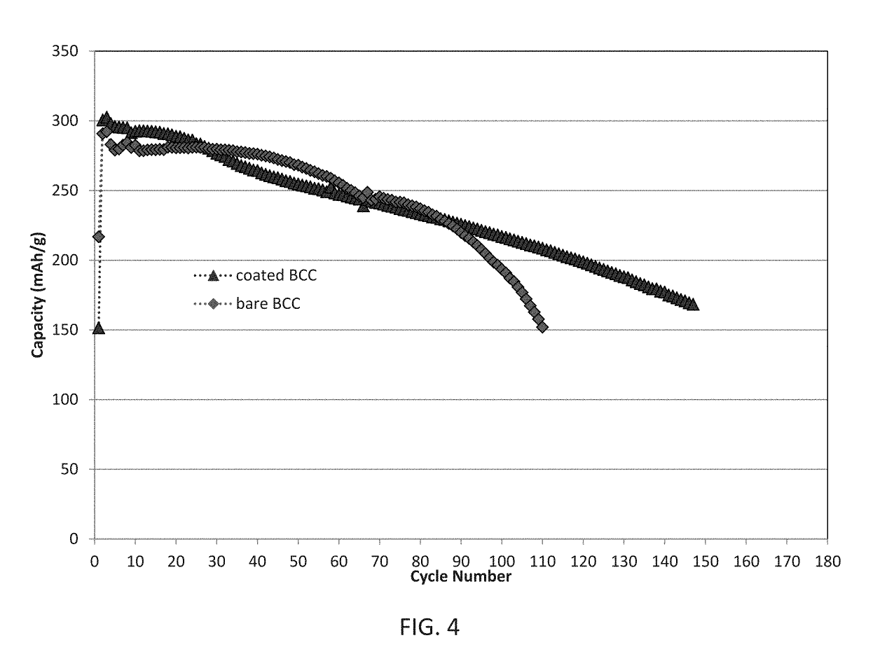

Also tested was an exemplary body-centered cubic (BCC) material. As illustrated in FIG. 4, the improvements of the coating and silicate in the electrolyte are less pronounced than for cells that employ A₂B₇ and AB₅ materials as actives in the negative electrode. However, there was some improvement in cycle life observed after 80 cycles, where the precipitous drop in residual capacity is retarded allowing performance for a significant number of additional cycles. BCC type metal hydrides generally contain a significant amount of vanadium. Vanadium oxide exhibits an acidic property and easily dissolves in an electrolyte with a strong base such as KOH. Dissolution of vanadium is more pronounced at elevated temperatures. The Y₂O₃ coating layer is less effective at hindering the vanadium dissolution, which reduces the magnitude of the improvement.

Overall, these studies show that for there is at least some improvement in cycle life in electrochemical cells that employ a silicate in the alkaline electrolyte and the functional coating on the negative electrode. This effect is most pronounced for electrodes that include rare earth elements in the anode active material such as AB₅ and A₂B₇ materials. The synergistic relationship between formation of a protective coating on the surface of the electrode and the effect of the silicate reacting with exposed electrode active material that occurs during decrepitation to promote relatively thin coatings leads to improved cycle life and cell performance, particularly at high temperatures.

Various modifications of the present invention, in addition to those shown and described herein, will be apparent to those skilled in the art of the above description. Such modifications are also intended to fall within the scope of the appended claims.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

The foregoing description is illustrative of particular aspects of the invention, but is not meant to be a limitation upon the practice thereof. The following claims, including all equivalents thereof, are intended to define the scope of the invention.

We claim:

1. An electrochemical cell comprising:
a positive electrode;
a negative electrode;
a separator; and
an alkaline electrolyte comprising a silicate;
wherein the negative electrode comprises a conductive substrate, an electrochemically active material layer coated onto the substrate, and a metal oxide/hydroxide coating layer, the coating layer directly on the active material layer opposite the substrate, the coating layer comprising a rare earth element.

2. The electrochemical cell of claim 1 wherein the rare earth is yttrium.

3. The electrochemical cell of claim 1 wherein the coating layer has a thickness of 0.01 to 10 micrometers.

4. The electrochemical cell of claim 1 wherein the electrochemically active material has a primary phase structure selected from the group consisting of BCC solid solution, AB₂, AB₅, and A₂B₇.

5. The electrochemical cell of claim 1 wherein the electrochemically active material comprises one or more rare earth elements.

6. The electrochemical cell of claim 5 wherein the rare earth element within the electrochemically active material is selected from the group consisting of Y, La, Ce, Pr, Nd, other rare earth elements, or combinations thereof.

7. The electrochemical cell of claim 5 wherein the electrochemically active material further comprises nickel.

8. The electrochemical cell of claim 1 wherein the electrochemical cell has a residual capacity of 80% or greater at cycle 100.

9. The electrochemical cell of claim 1 wherein the alkaline electrolyte comprises an alkaline metal to Si atomic ratio of less than 2.

10. The electrochemical cell of claim 1 wherein the electrochemically active material comprises Ni and one or more rare earth elements selected from the group consisting of Y, La, Ce, Pr, Nd, other rare earth elements, or combinations thereof.

11. The electrochemical cell of claim 1 wherein the electrochemically active material comprises Ni and one or more rare earth elements selected from the group consisting of Y, La, Cc, Pr, Nd, other rare earth elements, or combinations thereof, and the alkaline olyte comprises an alkaline metal to Si atomic ratio of less than 2.

12. A process of forming an electrochemical cell comprising:
forming a negative electrode by layering a coating of rare earth oxide onto an electrochemically active material; and
contacting the negative electrode with an alkaline electrolyte comprising a silicate.

13. The process of claim 12 wherein the electrochemically active material has a primary phase structure selected from the group consisting of BCC solid solution, AB₂, AB₅, and A₂B₇.

14. The process of claim 12 wherein the electrochemically active material comprises one or more rare earth elements.

15. The process of claim 12 wherein the rare earth element within the electrochemically active material is selected from the group consisting of Y, La, Ce, Pr, Nd, or combinations thereof.

16. A process of improving the high-temperature performance of an electrochemical cell comprising:
forming a negative electrode by layering an electrochemically active material on a conductive substrate and coating the electrochemically active material with a coating layer comprising a rare earth oxide;
contacting the negative electrode with an alkaline electrolyte comprising a silicate; and
forming a silicate film on a surface of the electrochemically active material.

17. The process of claim 16 wherein the alkaline electrolyte comprises an alkali metal to Si atomic ratio or less than 2.

18. The process of claim 16 wherein the electrochemically active material has a primary phase structure selected from the group consisting of BCC solid solution, AB₂, AB₅, and A₂B₇.

19. The process of claim 16 wherein the electrochemically active material comprises one or more rare earth elements.

20. The process of claim 19 wherein the rare earth element in the electrochemically active material is selected from the group consisting of Y, La, Ce, Pr, Nd, and combinations thereof.

21. The process of claim 16 wherein the silicate film comprises a rare earth element and Si.

22. The process of claim 21 wherein the silicate film comprises La₂(SiO₃)₃, Ce₂(SiO₃)₃, Pr₂(SiO₃)₃, Nd₂(SiO₃)₃ or combinations thereof.

23. The process of claim 16 wherein the electrochemically active material comprises a main phase structure of AB₂ or A₂B₇.

24. The process of claim 16 wherein the rare earth oxide in the coating layer comprises Y.

25. The process of claim 24 wherein the electrochemically active material comprises Y, La, Ce, Pr, Nd, or combinations thereof.

26. The process of claim 25 wherein the coating layer comprises yttrium oxide, and the electrochemically active material comprises lanthanum.

27. The process of claim 26 wherein the silicate film comprises La₂(SiO₃)₃.
